(19) United States
(12) Patent Application Publication
(10) Pub. No.: US 2025/0132474 A1
(43) Pub. Date: Apr. 24, 2025

(54) BIPOLAR BATTERY MODULE

(71) Applicant: Toyota Jidosha Kabushiki Kaisha, Toyota-shi (JP)

(72) Inventor: Junta TAKASU, Nagoya-shi (JP)

(73) Assignee: Toyota Jidosha Kabushiki Kaisha, Toyota-shi (JP)

(21) Appl. No.: 18/663,266

(22) Filed: May 14, 2024

(30) Foreign Application Priority Data
Oct. 20, 2023 (JP) 2023-181448

(51) Int. Cl. H01M 50/636; H01M 4/02; H01M 4/36

(52) U.S. Cl. CPC H01M 50/636; H01M 4/366; H01M 2004/029

(57) ABSTRACT

The bipolar battery module of the present disclosure has a structure in which a plurality of cells is stacked in a laminating direction of the bipolar electrodes. Each of the plurality of cells includes an internal space in which an electrolytic solution is accommodated between two positive-negative electrode foil adjacent to each other in the laminating direction. In a part of the outer peripheral part of each cell, a liquid injection opening for injecting an electrolytic solution into the internal space is formed by the sealing member. The liquid injection opening in at least a part of the cells has a shape widened to the adjacent cell side by disposing the peripheral edge part of at least one of the positive-negative electrode foil of the two positive-negative electrode foil so as to be offset to the adjacent cell side.

### CROSS-REFERENCE TO RELATED APPLICATION

This application claims priority to Japanese Patent Application No. 2023-181448 filed on Oct. 20, 2023, incorporated herein by reference in its entirety.

### BACKGROUND

### 1. Technical Field

The present disclosure relates to a bipolar battery module.

### 2. Description of Related Art

Japanese Unexamined Patent Application Publication No. 2022-16904 (JP 2022-16904 A) discloses a power storage module comprising at least one electrode unit. The power storage module disclosed in JP 2022-16904 A includes the following structure. In the electrode unit, a spacer for holding a space between a pair of current collectors joins a plurality of spacer members arranged along an outer peripheral edge of the current collectors. As described above, the spacer members are formed in a frame shape surrounding an active material layer. A seal member for sealing a seam is provided at an exposed portion of the seam between the spacer members on an outer peripheral surface of the spacer in a frame shape. The outer peripheral surface of the spacer has first regions covered by the seal member and second regions uncovered by the seal member.

### SUMMARY

FIG. 6 schematically illustrates an example of a liquid injection opening of a cell in a conventional bipolar battery module. In the battery provided with a bipolar structure shown in FIG. 6, an electrolytic solution is injected into an internal space 40P from an opening of each cell. Since a total thickness T of a separator 16P and a positive electrode layer 14P and a negative electrode layer 12P is the height of an internal space of a cell, the liquid injectability of the electrolytic solution is greatly influenced.

When the energy density of the positive electrode layer 14P and the energy density of the negative electrode layer 12P are increased, the thickness of the positive electrode layer 14P and the thickness of the negative electrode layer 12P are set to be thinner. When the thickness of the positive electrode layer 14P and the thickness of the negative electrode layer 12P become thinner, the total thickness T of the separator 16P and the positive electrode layer 14P and the negative electrode layer 12P becomes smaller, and the height of the internal space of the cell becomes lower. Therefore, a height (a space in a thickness direction) H of the liquid injection opening is also lowered, and the liquid injectability is lowered.

An issue of the present disclosure is to provide a bipolar battery module in which the liquid injectability of an electrolytic solution into an internal space of a cell is improved.

Means for solving the above issue include the following aspects.
(1) A bipolar battery module includes an electrode laminate and a sealing member.
In the electrode laminate, a plurality of bipolar electrodes is laminated via a separator, and the bipolar electrodes each include a positive electrode composite material layer disposed on a positive electrode foil side of a positive-negative electrode foil and a negative electrode composite material layer disposed on a negative electrode foil side of the positive-negative electrode foil.
The sealing member covers a peripheral edge part of the positive-negative electrode foil.
The bipolar battery module includes a structure in which a plurality of cells is stacked in a laminating direction of the bipolar electrodes.
Each of the plurality of cells includes an internal space in which an electrolytic solution is accommodated between two of the positive-negative electrode foils adjacent to each other in the laminating direction.
In a part of an outer peripheral part of each of the plurality of cells, a liquid injection opening for injecting the electrolytic solution into the internal space is provided by the sealing member.
In the liquid injection opening in at least a part of cells among the plurality of cells, the peripheral edge part of at least one of the two positive-negative electrode foils is disposed to be deflected toward an adjacent cell side, and the liquid injection opening is in a shape that extends to the adjacent cell side.
(2) In the bipolar battery module according to (1),
the liquid injection opening extending to the adjacent cell side is configured to be provided at an interval of one or more cells in the plurality of cells.
(3) In the bipolar battery module according to (1) or (2),
in the liquid injection opening extending to the adjacent cell side, the peripheral edge part of the positive-negative electrode foil is bent in a stepped shape; and
a portion closer to an end than a portion that is bent is covered with the sealing member.
(4) In the bipolar battery module according to any one of (1) to (3),
the plurality of cells is three or more cells, and a volume of the internal space of at least one of two cells located outermost in the laminating direction is minimum among volumes of the internal spaces of the plurality of cells.
(5) In the bipolar battery module according to any one of (1) to (4),
the liquid injection opening is sealed in a state in which the electrolytic solution is accommodated in the internal space of each of the plurality of cells.

According to the present disclosure, there is provided a bipolar battery module in which the liquid injectability of an electrolytic solution into an internal space of a cell is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a bipolar battery module according to the present disclosure;

FIG. 2 is a partial schematic cross-sectional view showing a part of a cross section taken along a A-A line in FIG. 1;

FIG. 3 is a partial schematic cross-sectional view illustrating an example of a state in which the liquid injection opening is sealed after the electrolytic solution is injected from the liquid injection opening into the internal space of the cell;

FIG. 4 is a partial schematic cross-sectional view showing a part of a cross section taken along a B-B line in FIG. 1;

FIG. 5 is a partial schematic cross-sectional view showing another embodiment of a liquid injection opening in a bipolar battery module according to the present disclosure; and

FIG. 6 is a partial schematic cross-sectional view showing an example of a liquid injection opening of a cell in a conventional bipolar battery module.

### DETAILED DESCRIPTION OF EMBODIMENTS

In the present disclosure, a numerical range indicated by using “to” means a range including numerical values described before and after “to” as a minimum value and a maximum value, respectively. In the numerical range described in the present disclosure in a stepwise manner, the upper limit value described in a certain numerical range may be replaced with the upper limit value of the numerical range described in another stepwise manner. The lower limit value described in a numerical range may be replaced with the lower limit value of the numerical range described in another stepwise manner. In the present disclosure, a combination of two or more preferred embodiments is a more preferred embodiment. In the present disclosure, the term “step” is included in the term as long as the intended purpose of the step is achieved, even if it is not clearly distinguishable from other steps as well as independent steps.

Hereinafter, an embodiment of a bipolar battery module of the present disclosure will be described with reference to the drawings. In the drawings, the same or corresponding parts are denoted by the same reference numerals, and description thereof will be omitted as appropriate. In addition, in the drawings, the same or corresponding portions, for example, the cell 10A, 10B, 10C, 10D, 10E, may be collectively referred to as the cell 10.

In addition, in the present disclosure, a bipolar battery module is referred to not only as a form in which an electrolytic solution is accommodated in an internal space of each cell and sealed, but also as a form before the electrolytic solution is accommodated in an internal space of each cell and sealed.

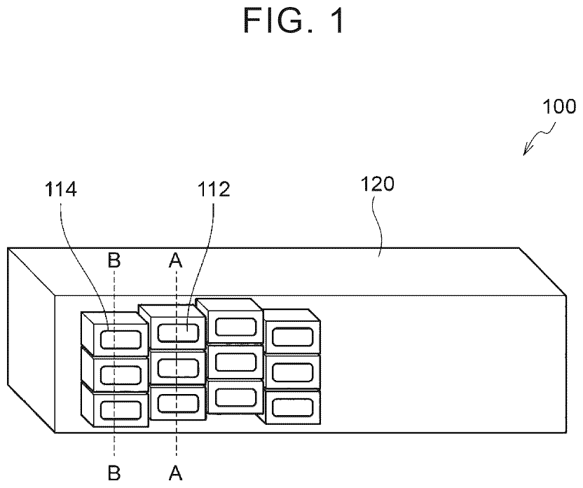

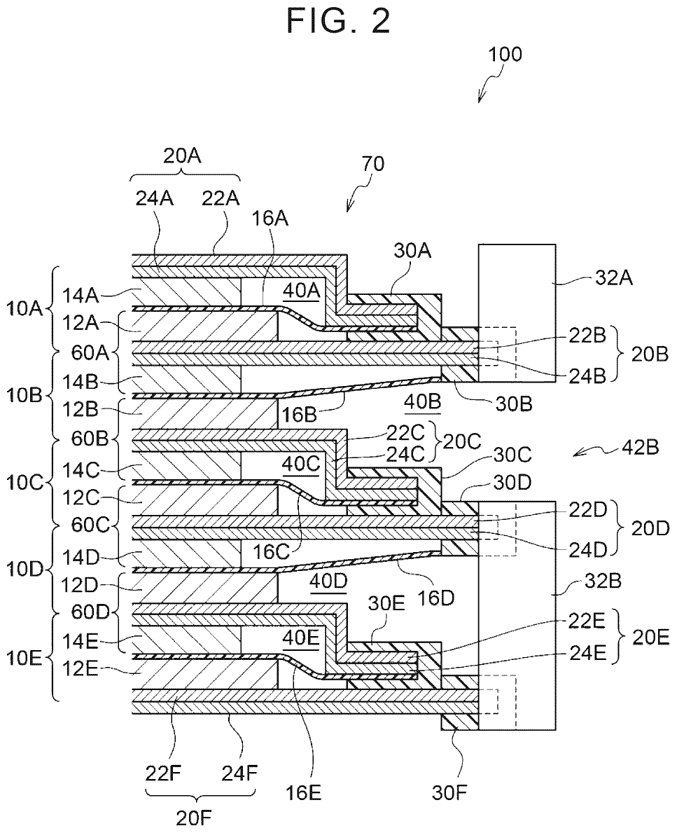

FIG. 1 is a schematic diagram illustrating an example of a bipolar battery module according to the present disclosure. A plurality of liquid injection nozzles 112, 114 is provided in the outer casing 120. FIG. 2 is a partial schematic cross-sectional view showing a part of a cross section taken along a A-A line in FIG. 1. The bipolar battery module 100 includes an electrode laminate 70 in which a plurality of bipolar electrodes 60 is laminated with a separator 16 interposed therebetween, and a sealing member 30 that covers a peripheral edge part of the positive-negative electrode foil (current collector) 20. The positive-negative electrode foil 20 is formed by bonding the negative electrode foil 22 and the positive electrode foil 24.

Each of the bipolar electrodes 60 has a configuration in which the positive electrode composite material layer 14 is disposed on the positive electrode foil 24 side of the positive-negative electrode foil 20, and the negative electrode composite material layer 12 is disposed on the negative electrode foil 22 side.

The bipolar battery module 100 has a structure in which a plurality of cells 10 is stacked in the laminating direction of the bipolar electrodes 60. Each cell 10 has an internal space 40 in which an electrolytic solution is accommodated between two positive-negative electrode foils 20 and 20 adjacent to each other in the laminating direction of the bipolar electrodes 60. A liquid injection opening 42 for injecting an electrolytic solution into the internal space 40 is formed by the sealing member 30 in a part of the outer peripheral part of each cell 10. In FIG. 2, the liquid injection opening 42B of the cell 10B is shown.

In the liquid injection opening 42B of the cell 10B, a peripheral edge part of the positive-negative electrode foil 20C (a portion where the negative electrode composite material layer 12B and the positive electrode composite material layer 14C of the positive-negative electrode foil 20C are not formed) of the positive-negative electrode foils 20B, 20C is bent in a stepped shape. A portion closer to the end than the bent portion of the positive-negative electrode foil 20C is covered with the sealing member 30C. On the other hand, the end portion of the separator 16B is welded to the sealing member 30B covering the peripheral edge part of the positive-negative electrode foil 20B.

The sealing member 30C at the end portion of the positive-negative electrode foil 20C contacts the positive-negative electrode foil 20D of the cell 10C adjacent to the cell 10B. Since 20C, 20D of the positive-negative electrode foil do not come into direct contact with each other, a short circuit is prevented. The peripheral edge part of the positive-negative electrode foil 20C is bent in a stepped shape and is arranged so as to be biased 30 toward the adjacent cell 10C, and the liquid injection opening 42B spreads toward the adjacent cell 10C. With such a configuration, it is easy to inject the electrolytic solution into the internal space of the cell 10B from the liquid injection opening 42B (sometimes referred to as an “enlarged opening” in the present specification).

In the bipolar battery module according to the present disclosure, in the liquid injection opening 42B of the cell 10B, it is sufficient that the peripheral edge parts of the positive-negative electrode foil of at least one of the two positive-negative electrode foils 20B, 20C disposed opposite to each other are disposed to be offset to the adjacent cell side. For example, a peripheral edge part of the positive-negative electrode foil 20B may be disposed to be offset to an adjacent cell 10A. Alternatively, the respective peripheral edge parts of the positive-negative electrode foils 20B, 20C may be arranged to be shifted toward the adjacent cell 10A, 10C, so that the liquid injection opening 42B may be further expanded.

The liquid injection opening 42B of the cell 10B is formed at a position corresponding to the liquid injection nozzle 112 of the bipolar battery module 100 shown in FIG. 1. By supplying the electrolytic solution through the liquid injection nozzle 112, the electrolytic solution is injected from the liquid injection opening 42B into the internal space of the cell 10B.

The electrolytic solution injected into the internal space of the cell 10B permeates through the negative electrode composite material layer 12 side and the separator 16B, and also permeates into the positive electrode composite material layer 14 side.

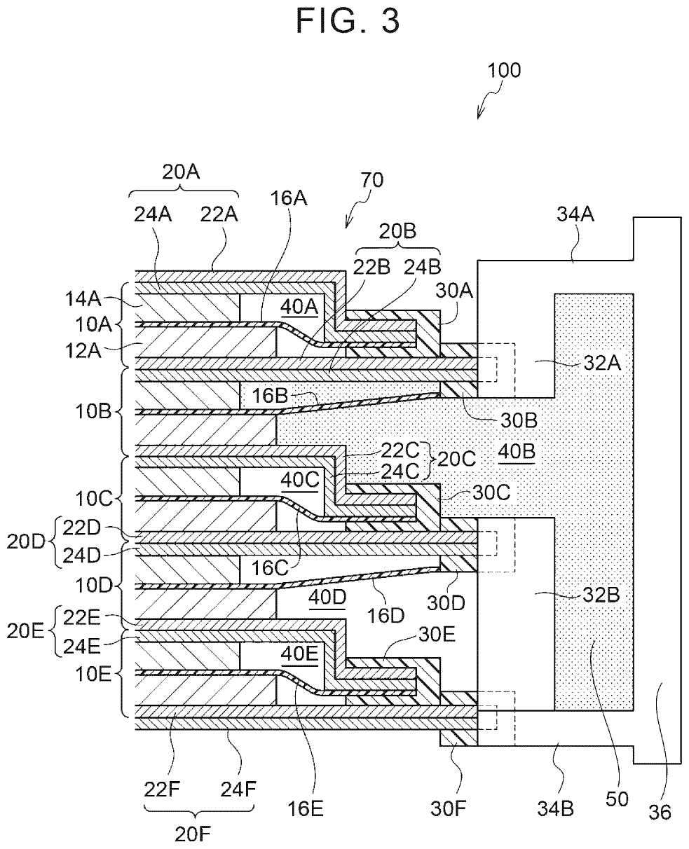

FIG. 3 is a partial schematic cross-sectional view illustrating an exemplary liquid injection opening 42B sealed after the electrolytic solution is injected from the liquid injection opening 42B into the internal space 40B of the cell 10B. The electrolytic solution 50 is injected into the internal space 40B of the cell 10B through the liquid injection opening 42B. After the injection, the liquid injection opening 42B is sealed by the injection port sealing members 32, 34, and 36. As a result, the electrolytic solution 50 injected into the cell 10B remains in the area surrounded by the positive-negative electrode foils 20B, 20C and the sealing member 36.

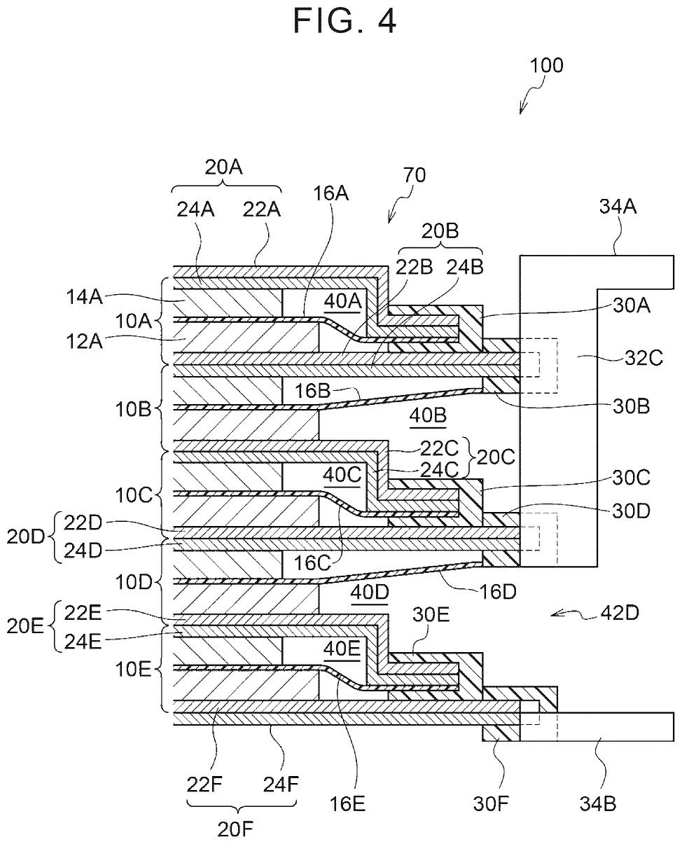

FIG. 4 is a partial schematic cross-sectional view showing a part of a cross section taken along a B-B line in FIG. 1. FIG. 4 shows the liquid injection opening 42D in the cell 10D. A peripheral edge part of the positive-negative electrode foil 20E is bent in a stepped shape and is arranged to be offset to an adjacent cell 10E. As a result, the liquid injection opening 42D of the cell 10D also extends toward the adjacent cell 10E. The liquid injection opening 42D of the cell 10D is formed at a position corresponding to the liquid injection nozzle 114 of the bipolar battery module. By supplying the electrolytic solution through the liquid injection nozzle 114, the electrolytic solution is injected from the liquid injection opening 42D into the internal space 40D of the cell 10D. Similar to the liquid injection opening 42B, after the liquid injection, the liquid injection opening 42D is sealed by a liquid injection port sealing member (not shown).

As shown in FIGS. 2 and 4, in the bipolar battery module 100 according to the present disclosure, the liquid injection openings (enlarged openings) 42B, 42D extending toward the adjacent cell side is formed at a distance of one cell. In the bipolar battery module according to the present disclosure, the enlarged opening may be formed at a distance of one cell or more, or the liquid injection opening of each cell 10 may have a shape extending to an adjacent cell at different positions in the outer peripheral part.

The cells 10A, 10C, 10E each have an injection opening (not shown) at a position other than the liquid injection opening 42B, 40D of the cell 10B, 10D, for example, on the other side. Each of the liquid injection openings of the cells 10A, 10C, 10E has a configuration in which the peripheral edge parts of the positive-negative electrode foil extend toward the adjacent cell side, so that the liquid injectability of the electrolytic solution is improved. In the respective internal spaces 40A, 40C, 40E of the cells 10A, 10C, 10E, the electrolytic solution is injected from the corresponding liquid injection nozzles (not shown) through the liquid injection openings, and then sealed.

The bipolar battery module 100 functions as a storage battery by injecting an electrolytic solution into the internal space of each cell 10 and sealing the liquid injection opening.

### Modification 1

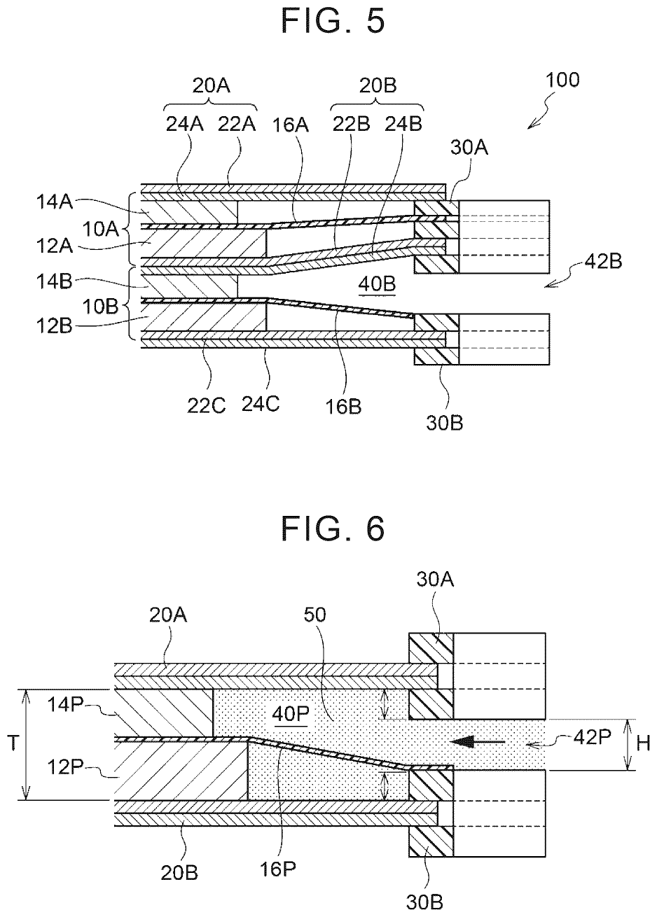

FIG. 5 is a partial schematic cross-sectional view illustrating another example of the liquid injection opening in the bipolar battery module according to the present disclosure. A peripheral edge part of the positive-negative electrode foil 20B of the cell 10B is disposed to be inclined toward an adjacent cell 10A. In this way, even if the peripheral edge parts of the positive-negative electrode foil of the respective cells are not bent in a stepped manner but are arranged so as to be inclined toward the adjacent cells, the liquid injection opening 42B is widened, and the liquid injectability is improved.

### Modification 2

The volume of the internal space of at least one of the two outermost cells (sometimes referred to as “outermost cells” in the present disclosure) in the laminating direction of the structure in which the three or more cells are stacked may be the smallest in the volume of the internal space of each of the other cells.

In the conventional bipolar battery module, when the inside of the cell is kept in a reduced pressure state, since the cells overlap each other, the degree of reduction in the inside of each cell cannot be monitored from the outside in the state of the module.

On the other hand, for example, in FIG. 2, when the cell 10A, 10E is the outermost cell, the volume of the internal space 40A of at least one outermost cell, for example, the cell 10A, is kept to be the smallest. When the pressure inside the cell increases due to the inflow of the outside air, the internal pressure of the outermost cell 10A having the narrowest internal space 40A increases most, and the presence or absence of an abnormal internal pressure can be determined visually or by measuring. For example, in the outermost cell 10A, the pressure inside the cell can be detected by applying a pressure sensor to the flat portion of the exposed exterior body. Accordingly, it is not necessary to monitor the internal pressure of all the cells of the bipolar battery module.

There is no particular limitation on how the internal space of the outermost cell 10A is narrowed. For example, as shown in FIG. 2, the following method and the like are exemplified.
(i) A method of bending the positive-negative electrode foil 20A to make the sealing member 30A longer than other cells to narrow the internal space 40A.
(ii) A method of narrowing the internal space 40A by placing a spacer (not shown) between the positive-negative electrode foils 20A, 20B of the outermost cell 10A.
(iii) A method of narrowing an internal space 40A by making an area of a positive electrode composite material layer 14A and a negative electrode composite material layer 12A larger than an area of a positive electrode composite material layer and a negative electrode composite material layer of another cell.

Hereinafter, the constituent members of the bipolar battery module according to the present disclosure will be described in detail, but the constituent members of the bipolar battery module according to the present disclosure are not limited to the following description.

### Electrode Laminate

The electrode laminate 70 is, for example, a rectangular parallelepiped. The electrode laminate 70 includes a plurality of bipolar electrodes 60 laminated via a separator 16. Specifically, the electrode laminate 70 includes a plurality of bipolar electrodes 60, a plurality of separators 16, a positive electrode layer-side termination electrode (not shown), and a negative electrode layer-side termination electrode (not shown). The plurality of bipolar electrodes 60 and the plurality of separators 16 is alternately laminated along the axial direction. The positive electrode layer-side termination electrode is laminated on the bipolar electrode located on the outermost side of one of the plurality of bipolar electrodes 60 in the laminating direction with a separator interposed therebetween. The negative electrode layer-side termination electrode is laminated on the bipolar electrode located on the outermost side of the other of the plurality of bipolar electrodes in the laminating direction with a separator interposed therebetween.

### Bipolar Electrode

The bipolar electrode 60 includes a positive-negative electrode foil 20, a positive electrode composite material layer 14, and a negative electrode composite material layer 12. The peripheral edge part of the positive-negative electrode foil 20 is welded to the sealing member 30. The positive electrode composite material layer 14 is formed on the positive electrode foil 24 side of the positive-negative electrode foil 20. The negative electrode composite material layer 12 is formed on the negative electrode foil 22 side of the positive-negative electrode foil 20. The bipolar electrode 60 may have a known configuration.

The positive-negative electrode foil 20 supply current to the positive electrode composite material layer 14 and the negative electrode composite material layer 12 during discharging or charging of the bipolar battery module 100. Examples of the positive-negative electrode foil 20 include aluminum foil, copper foil, nickel foil, titanium foil, and stainless-steel foil.

A coating layer may be formed on the surface of the positive-negative electrode foil 20 by a known method (for example, plating, spray coating, or the like). The thickness of the positive-negative electrode foil 20 may be 1 μm to 100 μm.

The positive electrode composite material layer 14 includes a positive electrode layer active material (for example, a lithium composite metal oxide having a layered rock salt structure, a metal oxide having a spinel structure, a polyanionic compound, or the like) capable of absorbing and desorbing charge carriers. The positive electrode composite material layer 14 may further include, if necessary, a conductive auxiliary agent (for example, carbon nanofibers or the like) for increasing the electron conductivity, a binder (for example, polyvinylidene fluoride or the like), an electrolyte support salt (lithium salt) for increasing the ion conductivity, a polymer electrolyte, and an additive (for example, trifluoropropylene carbonate, a filler as a reinforcing material or the like). The thickness of the positive electrode composite material layer 14 may be 2 μm to 500 μm.

The negative electrode composite material layer 12 includes a negative electrode layer active material (e.g., carbon (e.g., natural graphite, artificial graphite), a compound capable of alloying with lithium (e.g., silicon, tin, etc.)) capable of absorbing and desorbing charge carriers. The negative electrode composite material layer 12 may further contain, if necessary, a conductive auxiliary agent (for example, acetylene black or the like) for increasing the electron conductivity, a binder (for example, polyvinylidene fluoride or the like), an electrolyte support salt (lithium salt) for increasing the ion conductivity, a polymer electrolyte, and an additive (for example, trifluoropropylene carbonate, a filler as a reinforcing material or the like). The thickness of the negative electrode composite material layer 12 may be 2 μm to 500 μm. The thickness of the negative electrode composite material layer 12 may be the same as or different from the thickness of the positive electrode composite material layer 14. In the embodiment shown in FIG. 2, the length of the negative electrode composite material layer 12 is longer than the length of the positive electrode composite material layer 14.

### Separator

The separator 16 maintains a gap between the positive electrode composite material layer 14 and the negative electrode composite material layer 12 to prevent the occurrence of a contact short circuit, and allows a charge carrier such as lithium ions (for example, lithium ions) to pass therethrough. The peripheral edge part of the separator 16 is welded to the sealing member 30. The separator 16 is held by a sealing member 30. Examples of the separator 16 include a porous resin sheet and a nonwoven fabric. Examples of the material of the porous resin sheet include polyolefins (polypropylene, polyethylene, and the like). Examples of the material of the nonwoven fabric include polypropylene, polyethylene terephthalate, and methyl cellulose. The separator may have a known configuration.

### Positive Electrode Layer-Side Terminal Electrode

The positive electrode layer-side termination electrode includes a positive-negative electrode foil and a positive electrode composite material layer. The positive electrode composite material layer is formed on the negative electrode foil of the positive-negative electrode foil. The positive electrode layer-side termination electrode may have a known configuration.

### Terminal Electrode on the Negative Electrode Layer Side

The negative electrode layer-side termination electrode includes a positive-negative electrode foil and a negative electrode composite material layer. The negative electrode composite material layer is formed on the positive electrode foil of the positive-negative electrode foil. The negative electrode layer-side termination electrode may have a known configuration.

### Sealing Member

The sealing members 30, 32, 34, and 36 cover the peripheral edge parts of the positive-negative electrode foil 20, and form an internal space 40 between the adjacent bipolar electrodes 60, that is, in each cell 10. The internal space 40 contains the positive electrode composite material layer 14, the negative electrode composite material layer 12, and the separator 16, and further contains an electrolytic solution. In the present disclosure, the sealing members 30, 32, 34, and 36 restrain the electrolytic solution contained in the internal space 40 from leaking to the outside. The sealing members 30, 32, 34, and 36 may prevent moisture from entering the internal space 40 from the outside of the bipolar battery module 100. The sealing members 30, 32, 34, and 36 restrain the internal gas generated from the positive electrode composite material layer 14 or the negative electrode composite material layer 12 from leaking to the outside of the bipolar battery module 100 by charging, discharging, or the like.

The adjacent sealing members are welded to each other. The peripheral edge part of the positive-negative electrode foil 20 and the peripheral edge part of the separator 16 are held in a state of being embedded in the sealing member 30.

Examples of the material of the sealing members 30, 32, 34, and 36 include polyethylene, polystyrene, and an acrylonitrile-butadiene-styrene copolymer synthetic resin (ABS resin), modified polypropylene, and acrylonitrile styrene resin.

### Electrolytic Solution

The electrolytic solution is accommodated in the internal space 40. The electrolytic solution may include a non-aqueous solvent and a lithium salt. Examples of the lithium salt include LiClO₄, LiAsF₆, LiPF₆, LiBF₄, LiCF₃SO₃, LiN(FSO₂)₂, LiN(CF₃SO₂)₂. Examples of the non-aqueous solvent include cyclic carbonates, cyclic esters, chain carbonates, chain esters, and ethers. The electrolytic solution may contain an additive (e.g., lithium bis(oxalato)borate, etc.).

### Application

The application of the bipolar battery module 100 can be used, for example, as a power source for an electric four-wheeled vehicle, an electric two-wheeled vehicle, a portable device, an electric storage system, or the like. Examples of the electric four-wheeled vehicle include BEV: Battery Electric Vehicle, PHEV: Plug-in Hybrid Electric Vehicle, and HEV: Hybrid Electric Vehicle. The electric motorcycle includes an electric motorcycle or an electric assisted bicycle. Examples of the portable device include a smartphone, a tablet computer, a notebook computer, a power tool, and a video camera. Examples of the power storage system include a household power storage system, an industrial power storage system, and a power storage system (ESS: Energy Storage System).

What is claimed is:

1. A bipolar battery module comprising:
an electrode laminate in which a plurality of bipolar electrodes is laminated via a separator, the bipolar electrodes each including a positive electrode composite material layer disposed on a positive electrode foil side of a positive-negative electrode foil and a negative electrode composite material layer disposed on a negative electrode foil side of the positive-negative electrode foil; and
a sealing member that covers a peripheral edge part of the positive-negative electrode foil, wherein:
the bipolar battery module includes a structure in which a plurality of cells is stacked in a laminating direction of the bipolar electrodes;
each of the plurality of cells includes an internal space in which an electrolytic solution is accommodated between two of the positive-negative electrode foils adjacent to each other in the laminating direction;
in a part of an outer peripheral part of each of the plurality of cells, a liquid injection opening for injecting the electrolytic solution into the internal space is provided by the sealing member; and
in the liquid injection opening in at least a part of cells among the plurality of cells, the peripheral edge part of at least one of the two positive-negative electrode foils is disposed to be deflected toward an adjacent cell side, and the liquid injection opening is in a shape that extends to the adjacent cell side.

2. The bipolar battery module according to claim 1, wherein the liquid injection opening extending to the adjacent cell side is configured to be provided at an interval of one or more cells in the plurality of cells.

3. The bipolar battery module according to claim 1, wherein:
in the liquid injection opening extending to the adjacent cell side, the peripheral edge part of the positive-negative electrode foil is bent in a stepped shape; and
a portion closer to an end than a portion that is bent is covered with the sealing member.

4. The bipolar battery module according to claim 1, wherein:
the plurality of cells is three or more cells; and
a volume of the internal space of at least one of two cells located outermost in the laminating direction is minimum among volumes of the internal spaces of the plurality of cells.

5. The bipolar battery module according to claim 1, wherein the liquid injection opening is sealed in a state in which the electrolytic solution is accommodated in the internal space of each of the plurality of cells.
